(19) United States
(12) Patent Application Publication
(10) Pub. No.: US 2009/0063363 A1
(43) Pub. Date: Mar. 5, 2009

(54) SYSTEMS AND METHODS FOR CONSTRUCTING EXCHANGE TRADED FUNDS AND OTHER INVESTMENT VEHICLES

(75) Inventors: Howard B. Present, Wellesley Hills, MA (US); Michael Markov, Short Hills, NJ (US)

Correspondence Address: PATENT DOCKET ADMINISTRATOR;LOWENSTEIN SANDLER PC, 65 LIVINGSTON AVENUE, ROSELAND, NJ, 07068, US

(73) Assignee: F-SQUARED INVESTMENTS, LLC, Wellesley Hills, MA (US)

(21) Appl. No.: 12/053,397

(22) Filed: Mar. 21, 2008

Related U.S. Application Data
(63) Continuation-in-part of application No. PCT/US2006/036769, filed on Sep. 21, 2006.

(51) Int. Cl. G06Q 40/00

(52) U.S. Cl. 705/36 R; 705/37

(57) ABSTRACT

A method of forming an exchange traded fund (ETF) can include the steps of identifying an investor investment need, identifying funds that can be combined together to meet the investment goal, combining the identified funds to form a macro portfolio and converting the macro portfolio into an ETF. The step of converting the macro portfolio into an ETF can include one or more of generating a set of securities that, when combined, create a portfolio that tracks the performance of the macro portfolio, and constricting an index that is designed to track the performance of the macro portfolio. Other investment vehicles can be formed.

### CROSS-REFERENCE TO RELATED APPLICATION

This application claims the benefit of U.S. Provisional Patent Application No. 60/719,126, filed Sep. 21, 2005, the contents of which are hereby incorporated by reference herein. This application is a continuation-in-part of International Patent Application No. PCT/US2006/036769, filed Sep. 21, 2006, the contents of which are hereby incorporated by reference herein.

### FIELD OF THE INVENTION

Embodiments of the invention relate generally to the creation of investments deliverable through investment vehicles, and, particularly, to systems and methods for constructing investment vehicles including exchange traded funds.

### BACKGROUND OF THE INVENTION

One of the more popular new investment product vehicles over the last several years has been Exchange Traded Funds (ETFs). These vehicles create methods of commingling investment assets in a consistent strategy, managed by a single advisor, similar to open-ended mutual funds (“mutual funds”). ETFs, however, have a number of structural differences from mutual funds that have resulted in broad-based market appeal. Some of these differences include the ability, to buy or sell shares throughout the trading day, reduced expense ratios, and the ability to short ETFs.

To date, the ETFs have been effectively limited to index or other passive strategies. This limitation has been driven by the market trading mechanism ETFs and their sponsor firms use to enable investors to buy or sell shares. This mechanism is built around the role of a Market Specialist Firm or other Authorized Participants (“APs”) which create a market for die ETF during normal trading hours, enabling investors to either buy or sell shares. This function is performed by the APs creating shares of the ETF for sale to investors during the day, or redeeming such shares. At the end of the day, the APs settle their net position with the ETF to have the ETF either buy all outstanding shares that the APs own or to issue new shares to the APs to cover any net short positions they may have obtained during the day. The ETF provides special authorization for the APs to engage in such activity. Important to this trading mechanism is having the sponsoring manager or Investment Trust release daily holdings to the market. The APs use this data to hedge their share position (net long or net short) that they may own at any given point in time. Additionally, the holdings are used to calculate an estimated Net Asset Value (NAV) every 15 seconds during the day to ensure that the price that is quoted to the public for either sale or purchase is accurate relative to the true value of the ETF. This release of holdings includes a designation of what is known as a Redemption/Creation basket (a complete listing of the portfolio holdings released ever), night prior to the next day's trading) and a release of an estimated NAV every 15 seconds during the trading day.

Given that many retail investors have indicated that they prefer active management to passive strategies (e.g., over two-thirds of mutual funds are actively managed versus index mutual funds), there have been several attempts to create actively managed ETFs. The most straight-forward attempts to use active management within an ETF structure have failed due to the requirement for full disclosure of holdings, plus the SEC's designation that when a sponsoring firm or Investment Trust releases the full portfolio holdings to the APs, it is deemed a public disclosure and therefore requires the holdings to be made generally available to the public.

A problem presented by this requirement is the potential that releasing daily holdings will enable individuals not currently invested in the fund to identify the investment strategies and holdings of the manager, and attempt to “front run” the manager. An example of front running would be where a smaller investor builds a position in a stock in advance of what they believe the fund manager is building in the fund, and allowing the buying pressure of the manager, in the larger fund, to lift the stock. After the Manager completes the buy, the outside investor sells the holding and realizes the short-term gain. This concern is particularly relevant when the size of the fund or ETF is at the point where the investment manager will require several days or longer to build a desired position in a given stock (some of the industry's largest funds require their managers to take several weeks to build or unwind a desired position). Additionally, the concern relative to ETFs is particularly heightened in the context of creating an actively managed ETF that would be a clone to an actively managed mutual fund, due to the increased risk that the outside investors can front run the large mutual fund by the information about holdings that was obtained from the ETF. To date, both the active management industry, and in particular the SEC, have indicated that they will be resistant to any concept of an ETF that would create the potential for front running. (The SEC is interested in protecting the interests of individuals who were in the fund or ETF prior to when the outside investor began front running, and the management firm strives to protect its investment insights from poaching.)

In addition to the concern over front running, most investment managers have determined that releasing their portfolio holdings on a daily basis is not a desirable business activity. The core investment model of an investment manager is to charge a management fee to investors in exchange for their activities as investment manager (security selection and portfolio construction). These managers treat their portfolio holdings as a strategic corporate asset, and are very protective of releasing that data more frequently than required by regulations.

Other attempts to deliver active management through an ETF have been tried. The American Stock Exchange has filed a series of patent applications (see e.g., U.S. patent application Ser. No. 10/753,069, filed Jan. 8, 2004 and U.S. patent application Ser. No. 09/815,589, filed Mar. 23, 2001, the contents of which are hereby incorporated by reference herein) which use a mathematical model to create a Factor Tracking Portfolio of an actively managed fund to be used in place of the real portfolio holdings. A new Factor Tracking Portfolio is created each day through a technical manipulation, and is designed to closely replicate the performance of the actual portfolio during the trading day, while deviating from the real holdings at a large enough level to prevent outside investors from reverse engineering the original fund from the factor Tracking Portfolio.

The concerns raised with this methodology are two-fold: fears that the Factor Tracking Portfolio can still be used to reverse engineer the original portfolio; and the inefficiency that is created in the AP's ability to set an accurate bid-ask spread due to the requirement that the tracking portfolio deviate from the real portfolio. To date, this approach has not been utilized in a live product application.

Another approach that attempts to deliver semi-active management through an ETF has been introduced by several firms, one of which being Powershares Capital Management, LLC. This approach creates a quantitative investment model which is then used to build an investment portfolio. The sponsoring firm runs the quantitative model periodically (e.g., once a month), rebalances the portfolio, and then runs the fund as a “synthetic index fund” for the rest of the period (i.e., essentially uses a buy-and-hold strategy during the period based on the original portfolio established at the beginning of the period). While this strategy creates a method of delivering a form of semi-active management strategies within an ETF structure, it does not allow the type of active management referred to as fundamental or qualitative management, which is the traditional approach for the thousands of other investment management strategies that are typically referred to as active management.

Accordingly, there are certain deficiencies with the manner in which actively managed ETFs are attempted to be constructed. Therefore, a need exists for improved systems and methods for constructing ETFs that provide access to active management.

### SUMMARY OF THE INVENTION

Accordingly, there are certain deficiencies with the manner in which actively managed ETFs are attempted to be constructed. Therefore, a need exists for improved systems and methods for constructing ETFs that provide access to active management. Embodiments of the present invention satisfy this and other needs by providing systems and methods for constructing ETFs that provide access to active management, as well as applying these systems and methods for constructing other investment vehicles, such as mutual funds, variable annuities, separately managed accounts, structured notes, and other similar vehicles.

Embodiments of the invention can include the steps of identifying an investor need or investment objective, identifying existing mutual funds or other types of investment vehicles (“funds”) that can be combined together into a portfolio to meet the investment objective, combining the identified funds to form a “macro portfolio,” converting the macro portfolio into a portfolio of investable securities that track the macro portfolio (“Tracking Portfolio”) and then converting the Tracking Portfolio into any variety of investment vehicles, which could include ETFs. The step of converting the macro portfolio into an investable vehicle, including ETFs, can include building a portfolio of securities that are available on an exchange throughout the trading day, optimizing those securities for transaction cost reduction or trading efficiency, and comprises one or more of methods of generating a set of securities that, when combined, create a portfolio that tracks the performance of the macro portfolio.

An alternative embodiment of the invention includes the steps of identifying an investor need or investment objective, identifying existing mutual funds or other types of investment vehicles (“funds”) that can be combined together into a portfolio to meet the investment objective, combining the identified funds to form an index of mutual funds or other investment vehicles, converting the index of funds into a portfolio of investable securities that track the index of funds (“Tracking Portfolio”) and then converting the Tracking Portfolio into any variety of investment vehicles, which would include ETFs. The step of using investment techniques to create an investable vehicle, including ETFs, can include building a portfolio of securities that are available on an exchange throughout the trading day, optimizing those securities for transaction cost reduction or trading efficiency, and comprises one or more methods of generating a set of securities that, when combined, create a portfolio that tracks the performance of the index.

Another embodiment of the invention includes the steps of identifying an investor need or investment objective identifying existing mutual funds or other types of investment vehicles (“funds”) that can be combined together into a portfolio to meet the investment objective, combining the identified fends to form a “macro portfolio,” constructing a set of securities that track the macro portfolio, converting the securities in the Tracking Portfolio into an index, and creating an investment vehicle, such as an ETF, that tracks the index.

In addition, certain embodiments of the invention have broader application outside of the specific creation of an ETF. For example, the steps of identifying an investor need or investment objective, identifying existing mutual funds or other types of investment vehicles (“funds”) that can be combined together into a portfolio to meet the investment objective, combining the identified funds to form a “macro portfolio” and then using one or more of methods of generating a set of securities that, when combined, create a portfolio that tracks the performance of the macro portfolio, and then potentially optimizing those securities for transaction cost reduction or trading efficiency. This portfolio of securities can then be utilized within a variety of investment vehicles such as mutual funds, variable annuities, structured notes, exchange traded notes, separately managed accounts (SMAs), or institutional accounts. These alternative vehicles would benefit from the advantages created by the several steps leading up to the Tracking Portfolio or the Index of Securities which can include process diversification, customized investment solutions, reduced downside volatility, and improved persistency of performance.

Portions of the steps mention above in paragraphs 100131-100161 can be fully or partially automated and implemented by way of software applications, as described above, running on one or more computers or processors, as is known to those of skill in the art, as informed by the present disclosure. Portions of the steps can include human interaction or be configured to work in conjunction with human interaction, as is known to those of skill in the art, as informed by the present disclosure. In some embodiments, one or more of the modules may be configured to interface with each via a network and may be configured to interface with other modules, data stores and databases, as are known to those of skill in the art.

### BRIEF DESCRIPTION OF THE DRAWINGS

The invention can be understood from the detailed description of exemplary embodiments presented below, considered in conjunction with the attached drawings, of which:

FIG. 1 is a schematic diagram illustrating a method of constructing ETFs or other investment vehicles, in accordance with embodiments of the invention,

FIG. 2 is a flow diagram illustrating a method of constructing ETFs and other investment vehicles (“ETF+”), in accordance with embodiments of the invention; and

FIG. 3 is a schematic diagram illustrating a system for constructing an ETF and other investment vehicles, in accordance with embodiments of the invention.

It is to be understood that the attached drawings are for purposes of illustrating the concepts of the invention.

### DETAILED DESCRIPTION OF THE INVENTION

Embodiments of the invention are directed to systems and methods of constructing a variety of investment vehicles, including ETFs, which provide access to active management.

To address the investing public's desire to gain access to active management within an ETF structure, and to address the concerns with or limitations of current approaches, an alternative approach, with several methods, for delivering active management through an ETF is described herein.

With embodiments of the invention, there is identified a select number of mutual funds or other investment vehicles such as closed end funds or even hedge funds that publish or otherwise make available a periodic net asset value or total return, such as a daily or monthly net asset values (collectively referred to herein as “Funds”). These Funds can be combined together to meet an existing or potential investment goal.

The determination of the investment goal can come from any variety of sources. The investment goal might be a traditional category of investments (large cap growth equities), it can reflect a desired investment strategy (deep value equities), it can address a specific investor need (dividend yield from equities), or it can represent other investment considerations.

The identification of the Funds can also be accomplished through a variety of methods. The art and science of manager selection, and Fund selection, has expanded significantly in the past decade, with many firms having significant teams of professionals dedicated to the effort. Traditionally, the exercise includes screening historical performance of an investment through a database (examples include Morningstar, Mobius, MPI Stylus, eVestment Alliance) against a variety of screening criteria (examples include performance, relative performance, risk considerations, positioning, investment characteristics, portfolio construction techniques). These steps can be fully or partially automated and implemented by way of software applications, as described above, running on one or more computers or processors, as is known to those of skill in the art.

Other quantitative techniques for evaluating a manager or a Fund include performance based attribution software programs and holdings based attribution software programs.

Some practitioners will then supplement the quantitative screening with qualitative screening, which can include evaluation of published information about the management team and process or interviews with the management team.

In addition to the industry standards of selecting individual Funds, there are at least two additional methods that are not commonly applied. The first such method is to screen the funds for specific investment characteristics that are desired to be included in the macro portfolio. The individual Fund screening would be accomplished by the variety of means and tools detailed above. The specific investment characteristics can include such factors as risk profiles, performance patterns in different investment markets, non-normality to the investment track record, End high covariance or low covariance to established benchmarks or reference points. The concept behind this approach is that if a fund has a proven historical track record of reliably delivering a specific investment characteristic, such as outperforming its peer group in a down market; then it is reasonable to assume that that fund will have a high probability of outperforming its peer group in the next down market cycle. However, a high probability is not e certainty.

Given the redundancy that occurs from blending multiple Fund investment processes and Fund managers together into the Portfolio of Funds, if all or the majority of the Funds that are selected have the same historical track record of outperforming the same peer group in a down market, then there is a statistically higher probability that the Portfolio of Funds will outperform the peer group in the next down market than for any one of the Funds by itself. The portfolio effect therefore can result in a higher confidence of the final product delivering key investment characteristics. This methodology can be fully or partially automated and is typically implemented by way of software applications as described above, running on one or more computers or processors, as is known to those of skill in the art.

A second additional screening consideration is based on the diversification benefit that is achieved through the blending of multiple managers and processes. The theory of diversification is a well understood concept in the industry, and effectively reflects that combining two or more investments into the same portfolio that are not perfectly correlated, or have a covariance less than 1, will result in the overall portfolio having reduced volatility.

That principal is most commonly applied to portfolios constructed of individual securities, but works the same for portfolios constructed of investment vehicles. Therefore the incremental screening consideration would be to identify funds that have covariances between one another that are less than 1, and by combining them together it will reduce the overall portfolio volatility. This methodology can be fully or partially automated and is typically implemented by way of software applications, as described above, running on one or more computers or processors, as is known to those of skill in the art.

Means for determining covariance or correlation coefficients are common in the industry, with multiple software applications available to do so.

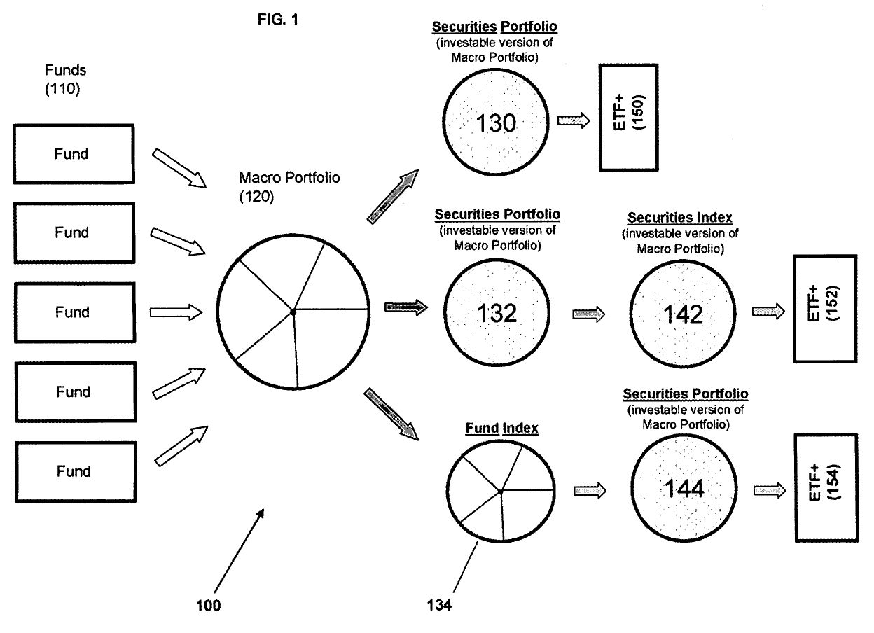

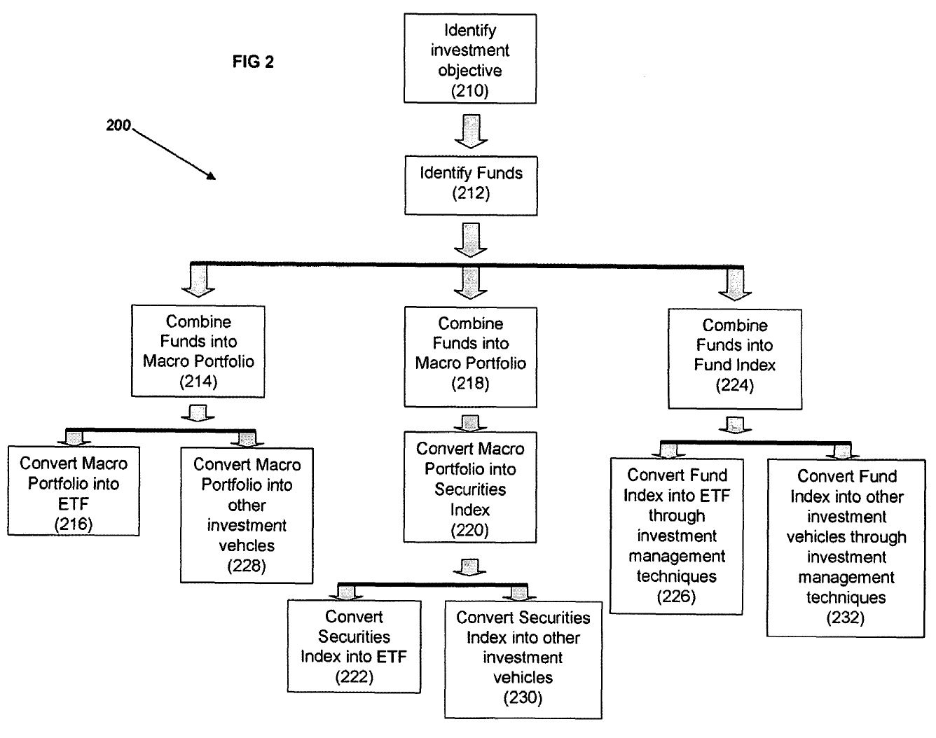

With reference to FIGS. 1 and 2, in the method 200 for creating an ETF, after identifying one or more investment objectives (Stop 210) and identifying funds that meet those objectives (Step 212), as described above, this “Portfolio-of-Funds” is then, through one of three methods, converted into an ETF or used as the basis for construction of other investment vehicles. The underlying Funds could be all actively managed, or reflect a group of Funds that include active, passive, or structured strategies.

One of the three methods of converting the Portfolio of Funds into an ETF or other investment vehicle is to combine or blend them together to create an integrated portfolio (referred to herein as the “Macro Portfolio”). (Step 214). The Macro Portfolio can then be converted into die targeted investment vehicle by generating a set of securities that, combined together, create a portfolio that tracks the performance of the Macro Portfolio (Tracking Portfolio). The methods of creating the Macro Portfolio and converting the Macro Portfolio into a Tracking Portfolio are detailed below. The ETF or other vehicles can be created directly from this portfolio of securities. (Steps 216 and 228).

The second method is to combine or blend the Funds together to create an index of Funds (“Fund Index”). (Step 224). This Fund Index is then converted to an ETF or other investment vehicle through investment management techniques that result in a portfolio of securities that, when combined together, create a portfolio that tracks the performance of the Fund Index. (Steps 226 and 232). This Fund Index can be published similar to other existing indices, or it can be considered a private index. The method of creating the Fund Index is also detailed below.

The third method is to combine or blend the Portfolio of Funds together to create the Macro Portfolio. A set of securities is then generated that, combined together, create a portfolio that tracks the performance of the Macro Portfolio. (Step 218). This set of securities is then converted into an index (“Securities Index”) that will track the performance of the Portfolio of Funds. (Step 220). The Securities Index is then converted into an ETF or other investment vehicle through traditional means. (Steps 222 and 230). This Securities Index can be published similar to other existing indices, or it can be considered a private index. The method of creating the Securities Index is also detailed below.

Thus, with further reference to FIG. 1, a number of identified funds 110 can be combined to form a macro portfolio 120.

From the macro portfolio 120, a portfolio of securities 132 is generated that, combined together, create a Tracking Portfolio that tracks the performance of the macro portfolio 120. The ETF or other investment vehicles (“ETF+”) 150 can be created directly from this portfolio of securities 132.

Alternatively, from the macro portfolio 120, the funds can be combined together to form a Fund Index 134. The Fund Index can be converted to a securities portfolio 144, which, in turn, can be converted to the desired investment vehicle 154.

Alternatively, from the macro portfolio, a set of securities 132 can be generated to create a Tracking Portfolio 132. The Tracking Portfolio 132 can then be converted to a securities index 142, and then the securities index 142 can be converted to the desired investment vehicle 152.

Constructing a Macro Portfolio Including Actively Managed Investment Vehicles, Passively Managed Commingled or Investment Vehicles, and Structured Investment Vehicles.

The method of blending the individual Funds into the Macro Portfolio or Fund Index can be based on a variety of methodologies that reflect portfolio construction principles (given the similarities in construction approach for both the Macro Portfolio and the Fund Index, we will use the term “Macro Portfolio” to reflect both). Whichever methodology is chosen, in certain embodiments, it should be maintained with reasonable consistency in order to improve overall investment results. The resulting Macro Portfolio can be constructed in such a manner that it is an investable portfolio (i.e., all of the securities within the portfolio are publicly available for purchase in the format and pricing scheme that is used within the Macro Portfolio), or it can be constructed in such a manner that it is not investable directly (e.g., a set of mutual funds where the daily value of the funds is synthetically adjusted to reflect gross of fee performance by increasing the daily performance of each fund by the daily fund expense ratio, the resulting portfolio will have a cumulative track record that could not be purchased directly) The latter version would traditionally be referred to as a reference portfolio or a benchmark portfolio.

The primary considerations used when constructing the Macro Portfolio are the weighting scheme and the rebalancing scheme.

Several weighting schemes are available. The first such method would be to use an equal weighting approach. For example, if there are 10 Funds used within the Macro Portfolio, each Fund would be initially set to a 10% weight within the Macro Portfolio 120, as shown in FIG. 1.

The second weighting methodology would be one where the resulting positioning of the Macro Portfolio, as determined by blended capitalization and investment style, would be established in such a manner as to minimize the tracking error of the Macro Portfolio to that of an external peer group or third party public index. The means of determining the blended style and capitalization is most effectively accomplished through the use of performance based attribution software. One of the more common such tools is sold by Markov Processes International (MPI) and is known as MPI Stylus. One of the advanced functions of MPI stylus allows a user to export the track records of existing funds, combine those track records (and potentially the track record of private investment vehicles or investment vehicles that are not included within the MPI database) into a composite track record. The track record can at this time also be modified to reflect desired pricing changes, such as converting the funds to gross of fee performance as described above.

The composite track record is then loaded back into MPI Stylus and the core functionality of the software allows a user to model and describe quantitatively, the capitalization and investment style of the Macro Portfolio. The performance based attribution software also allows a user to evaluate and model the capitalization and investment style positioning of a large number of indices as well as the median or other predefined ranking within a peer group (such as the top quartile position of a Morningstar peer group).

After generating the historical performance track record of the Macro Portfolio (adjusted in the manner desired, and described above) and gaining access to the historical performance track record of the underlying Funds as well as the index or peer group desired, determining a weighting scheme that minimizes the tracking error between the two can be accomplished in a variety of manners. The technical definition of tracking error refers to the standard deviation of the daily error between the two track records (i.e., the standard deviation of a series of numbers generated by subtracting the daily percentage change for investment one from the daily percentage change from investment two), and as such the objective of this effort is to minimize the standard deviation. This is accomplished by creating a weighting of the various Funds in the Macro Portfolio in such a manner as to reduce that standard deviation. By understanding the investment positioning of each underlying Fund, the resulting investment positioning of the Macro Portfolio is adjusted by overweighting or underweighting a Fund in the desired manner. For example, if it is needed to shift the Macro Portfolio weighting to a positioning that is larger capitalization, then one or more of those Funds that have a capitalization greater than the current positioning of the Macro Portfolio would be over-weighted. In some embodiments, one or more of the above steps may be configured to interface with each via a network, and may be configured to interface with other programs, data stores and databases, as are known to those of skill in the art.

A manual approach to this exercise would be to engage in a trial and error method. Other software programs, including Microsoft Excel and MPI Stylus, have the ability to optimize the results to reduce tracking error on an automated basis. Custom computer software programs can be built to achieve this goal as well.

A third weighting scheme can be applied by itself or in addition to one of the schemes detailed above. This weighting scheme is designed to reflect an investment view of the marketplace, and therefore position the Macro Portfolio to outperform. The core concept behind this approach is that the manager of the Macro Portfolio has a view that certain investment markets, styles, or asset classes will outperform others.

An example of how this would be implemented into a weighting scheme would be where the manager feels that growth will outperform value. They would take those Funds within the Macro Portfolio that have a greater exposure to growth styles (as determined by MPI Stylus or other means) and give them a higher weighting, those with a lesser exposure to growth receive a lower weighting. Other techniques are commonly used to further modify the results, including Factoring in risk considerations. Mean variance optimization tools, efficient frontier modeling, or Monte Carlo modeling are all tools used in this effort in the industry today.

This weighting scheme can be applied independently (traditionally referred to as a Strategic Asset Allocation) or cam be applied as an overlay to one of the prior weighting schemes detailed above. In this latter approach, the initial weighting scheme is adjusted to reflect shorter-term views of the market. This model would traditionally be referred to as Tactical Basset Allocation, and would be implemented in the same manner as described for the Strategic Asset Allocation approach. This methodology can be fully or partially automated and is typically implemented by a way of software applications, as described above, running on one or more computers or processors, as is known to those of skill in the art.

The final weighting consideration can be done to reflect SEC guidelines regarding creating an investable index. Although the Macro Portfolio does not necessarily need to meet these objectives in all cases, in some embodiments, meeting index requirements are required, as would be understood by one of skill in the art, as informed by this disclosure. The considerations for index construction have to do with securities concentration, diversification, and liquidity, and are generally available throughout the industry including through the SEC.

One important differentiation between the Macro Portfolio and Fund Index is that the latter step of addressing SEC guidelines for index construction can be applied at al times for the Fund Index.

In certain circumstances, the option of rebalancing is important to determine after deciding upon the weighting scheme. The benefits of rebalancing include maintaining the positioning biases of the Macro Portfolio and to improve investment results. Several recent studies have shown that rebalancing multiple investment strategies or Funds on a quarterly, semi-annual or annual basis back to the target weighting can improve total return and reduce overall volatility.

The investment concept behind this performance improvement reflects a reversion to the mean for the various alpha and beta components of the various Funds. In general, rebalancing can be done automatically after some specific period of time (e.g., annually), can be triggered based on a set level of drift from the target weighting (e.g., a movement of any fund of 5 percentage points from the target weighting), or a combination of the two. This methodology can be fully or partially automated and is typically implemented by way of software applications, as described above, running on one or more computers or processors, as is known to those of skill in the art.

Determining the Securities Required to Replicate the Performance of the Macro Portfolio.

There are several methods of obtaining specific securities and a portfolio construction methodology that can be used to create a portfolio of securities replicate or track the performance of the Macro Portfolio. Potential options are listed below, but reflect the dual activities of identifying the proper securities and then the construction technique to convert, those securities into the correct portfolio with appropriate weightings to achieve the desired goal.

Identifying Securities to be Used in the Final Portfolio, Including Identifying Holdings for the Constituent Funds.

Several methods can be used to obtain or approximate holdings for the Portfolio of Funds. One of these approaches can be used individually, some combination of the approaches might be used, or some later developed alternative approach that has not been identified to date but is consistent with the goal and approach of the other methods could be used.

(1) Cooperation of the constituent Fund managers: A method for obtaining the holdings is to obtain them through the cooperation of the actual Fund manager. These holdings can be accessed from either the Fund manager or an intermediary on a live, daily basis or with a short-term Lag.

(2) Accessing public filings: Fund managers and larger investment managers are required to provide periodic filings of Fund holdings to the SEC and to existing shareholders in annual aid semi-annual reports. Some firms have decided to provide full or partial holdings to the public on a more frequent basis. The final Portfolio of securities used to track the performance of the Macro Portfolio (“Securities Portfolio” or “Composite Macro Portfolio”) can be constructed from these public filings and any other voluntarily public holdings disclosures of the Fund, although a Securities Portfolio constructed through this method can reflect a significant delay between the actual Fund manager decisions and the capture by the Securities Portfolio.

(3) Generating holdings through dynamic multi-factor modeling, massive scale optimization, or other replication techniques which utilizes the constituent Funds' daily net asset value (“NAV”) and other public information to generate up-to-date holdings: This approach can utilize, by way of example, the technology detailed in U.S. patent application Ser. No. 10/431,838, which is (discussed above. Alternatively, other now known or later developed technologies Can be used. This activity is required to be fully or partially automated and is typically implemented by way of software applications, as described above, running on one or more computers or processors, as is known to those of skill in the art.

A variation of method (3) above would be to apply the dynamic multi-Factor modeling to the real or synthetic track record of the Macro Portfolio. This is a much more complicated calculation, but would have the benefit of once the list of securities was identified it would not need further manipulation prior to being converted into the Securities Portfolio. This activity also is required to be fully or partially automated and is typically implemented by way of software applications, as described above, running on one or more computers or processors, as is known to those of skill in the art.

(4) Partial data ETF: Some or all managers within the Macro Portfolio may be willing to disclose only partial data, such as top 10 holdings or top 90% of assets. This information is then used in creating of the Securities Portfolio.

(5) Any combination of the above: For example, some managers constituting the Macro Portfolio may disclose only partial holdings information such as top positions, new purchases, sell-offs, etc. that is then amended either by public data or an application of models (3) or both.

Other mechanisms for identifying securities to be used in the final Securities Portfolio would include evaluation of public benchmarks in the investment space (i.e., the top 50 holdings within the Russell 1000 Value index for a Macro Portfolio competing within the large cap value space), or individual insights that the ETF manager or sponsor might have.

Building the Securities Portfolio from the Identified List of Securities or Fund Holding.

the most straightforward means would be to utilize a “bottoms-up” approach. This method would represent taking the holdings linked to each underlying Fund in the Macro Portfolio and weight them together to form the Securities Portfolio by using the same weighting as the Fund has within the Macro Portfolio. For example, assume fund A represents 10% of the Macro Portfolio, and it was determined by one of the methods above that Fund A has four holdings with the following weights: Holding 1-50%, Holding 2-25%, Holding 3-10%, Holding 4-15%. In the Securities Portfolio, those holdings would represent their same weighting as within Fund A, but at only 10% allocation. Therefore in the final Securities Portfolio Holding 1 would represent 5%, Holding 2 2.5%, etc. (Obviously, if one the holdings is replicated in another of the Funds, the final weighting of each Holding would be the sum of the contributions from the various Funds.) This process may be fully or partially automated and is typically implemented by way of software applications, as described above, running on one or more computers or processors, as is known to those of skill in the art.

Depending on the number of holdings represented by the Securities Portfolio, the portfolio can be analyzed by an optimization and consolidation algorithm to generate a modified Securities Portfolio with a more concentrated number of holdings. The means of this algorithm would be to identify a portfolio of securities with a smaller number of holdings that has as small a tracking error as possible to the original Securities Portfolio. This approach can be done in many ways, although previously we discussed a means of creating two portfolios designed to have a minimal tracking error to one another.

Other modifications or optimizations to the Securities Portfolio can be accomplished to reduce tax liabilities or reduce turnover. Turnover reflects a very similar principal to that of the reduced holdings optimization, except that the alternate portfolio would be designed to have fewer trades in the open market. The means of reducing tax liabilities can be as simple as reducing turnover, and associated taxable events of generating realized gains, or could be as sophisticated as using tax lot accounting and trade identification means to reduce the amount of the realized gains. There are currently several firms that provide this service on a formal basis, including Smartleaf, Inc., in Cambridge, Mass., which can be used if the investment manager does not have the internal tools or trading systems to implement the most sophisticated approaches.

A “top-down” approach can also be used. This approach would typically take the form of factor analysis and dynamic multi-factor modeling computer programs that can use the daily values of the Macro Portfolio plus other available security performance data to construct a simulated tracking portfolio, as is described in U.S. patent application Ser. No. 10/431,838, the contents of which are hereby incorporated by reference herein. Alternatively, other known or later developed technologies can be used. The inputs into this analytical exercise would be the various holdings and securities identified above.

Regardless of the methodology ad final consideration exists which would be to optimize the Securities Portfolio to meet the SEC guidelines for an investable index. This concept has been discussed above.

Converting the Securities Portfolio into an Investment Vehicle, Including But Not limited to ETFs, mutual funds, variable annuities, separately managed accounts, Institutional Separate Accounts, Closed End Funds, and Structured Notes and Other Structured Products.

The actual or modified Securities Portfolio can be converted into virtually any investment vehicle, including ETFs. For purposes herein we will refer collectively to the broader set of investment vehicles (mentioned above) as “ETF+”. There are at least two approaches to perform this conversion, as illustrated in FIG. 1 and FIG. 2. The first is to use the Securities Portfolio directly to generate an ETF+. This method can use a daily representation of the portfolio, or can update the Securities Portfolio with a lag, such as a weekly or monthly, basis, and run the portfolio as a synthetic index for the remainder of the period.

In some circumstances, the optimal methods based on transaction efficiency for the ETF+s (plus that of the efficiency of APs ability to work with ETFs) may be to update the portfolio periodically such as weekly, which would maintain a timely representation of an ETF+ while limiting some of the transaction costs that the portfolios would need to incur. These transaction costs would be translated back to investors through higher bid-ask spreads in the case of ETFs. Alternatively, in other circumstances other update schedules can be used.

A second approach can be to use an investable version of the Macro Portfolio to create a listed index. This approach could force the Macro Portfolio to be evaluated by the traditional construction screens required to create and publish indices, and potentially be modified accordingly. Once the index is available, an ETF+ would then be designed to track the index in a manner consistent with currently available investment vehicles.

Converting the Fund Index into an ETF or Other Vehicle Through Investment Management Techniques.

The Fund Index can be converted into an ETF+ using a variety of investment management techniques that would generate a set of investable securities within an ETF+ that is designed to accurately track the Index. Investment management techniques are currently used in the industry when the literal translation of the index into an ETF+ is problematic due to liquidity reasons, cost considerations, or index construction guidelines. An example of this is where an ETF+ designed to track the Wilshire 5000 index does not use all 5000 stocks from the index, but instead uses optimization techniques to reduce the number of holdings down to approximately 1,250.

The key investment management techniques that would be utilized are the same ones detailed above to create a Securities Portfolio designed to track the Macro Portfolio. They also are often fully or partially automated and are typically implemented by way of software applications, as described above, running on one or more computers or processors, as is known to those of skill in the art.

While embodiments of the invention have been described by way of having certain steps, embodiments of the invention can also include methods whereby certain of the steps are omitted, performed in a different sequence than that of the provided examples, certain of the steps are performed concurrently, and/or certain of the steps are performed more than once.

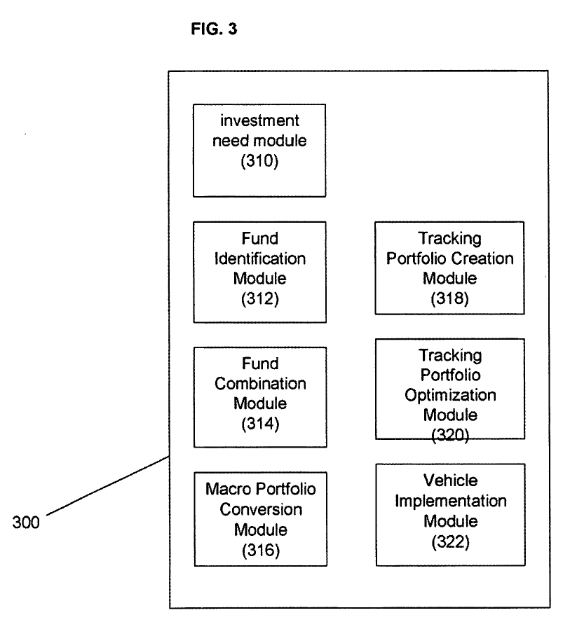

With reference to FIG. 3, in certain embodiments, a system 300 for constructing an ETF or other investment vehicle can include an investment module 310, a fund identification module 312, a fund combination module 314 and a macro portfolio conversion module 316, a Tracking Portfolio creation module 318, a Tracking Portfolio optimization module 320, and a vehicle implementation module 322. As described above, investment module 310 can be used to determine the investment objectives, fund identification module 312 can be used to identify funds that meet the objectives, fund combination module 314 can be used to combine the funds, and macro portfolio conversion module 316 can be used to convert the macro portfolio into a portfolio of individual securities that can track the portfolio, Tricking Portfolio creation module 318 can be used to weight the individual securities into a portfolio with the ability to accurately track the macro portfolio or an Index that accomplishes the same goal, the Tracking Portfolio optimization module 320 can be used to improve trading costs or efficiency, and vehicle implementation module 322 can be used to convert the Tracking Portfolio or optimized Tracking Portfolio into one or more investment vehicles, including ETFs. Portions of the modules can be fully or partially automated and implemented by way of software applications, as described above, running on one or more computers or processors, as is known to those of skill in the art, as informed by the present disclosure. Portions of the modules can include human interaction or be configured to work in conjunction with human interaction, as is known to those of skill in the art, as informed by the present disclosure. In some embodiments, one or more of the modules may be configured to interface with each other via a network (e.g., an intranet or the Internet, via wired or wireless methods), and may be configured to interface with other modules, data stores and databases, as are known to those of skill in the art.

Embodiments of systems and methods as described herein can have several advantages over other methods. A first series of advantages can be observed through the creation of a Macro Portfolio of a select number of constituent Funds.

The portfolio construction process can be replicated with a virtually unlimited number of parameters, enabling the ability to create a whole new suite of investment solutions. These “virtual fund-of-funds” ETF+'s can be able to access essentially all actively managed investment vehicles while also creating investment solutions with different, and potentially improved, investment characteristics than currently available.

The activity of building a portfolio from several underlying Funds creates a diversification of process. This process diversification can result in a reduction in overall portfolio volatility, and can make an ETF+ less subject to performance declines that any one individual process might be vulnerable to.

The activity of building a portfolio from several underlying Founds crates a redundancy of investment characteristics. This process redundancy can result in an improved confidence in an ETF+ delivering the targeted investment characteristic than would normally be found in an individual Fund.

By creating a Macro Portfolio from several individual Funds, an ETF+ can capture the collective insights of the constituent Funds while minimizing the possibility of reverse engineering the portfolio back to the underlying constituent Funds. This results from the distortion that is created by blending the Funds together into a composite portfolio, as well as the distortion that can arise from the investment management techniques used to create the Securities Portfolio. This benefit reduces, if not eliminates, the front running concern specifically identified for ETFs.

Because the Macro Portfolio reflects the composite decision-making of the underlying Funds, it is unlikely that there will be any apparent or relevant investment management trends reflected within the Macro Portfolio, die index, or the ETF+'s holdings. Therefore, it is highly unlikely that there would be any value in attempting to front run the Macro Portfolio, the index, or an ETF+.

By way of certain embodiments of the invention, active managers cal be translated to virtually any investment vehicle structure, with the resident advantages that each vehicle might create.

Regarding ETFs specifically, this method of delivering active management requires no refinement of the current ETF approach, which therefore enables it to utilize the existing AP network without change or modification.

The Macro Portfolio can be a literal representation of underlying Funds, can be a tracking portfolio of larger groupings of portfolio, or can be a simulated series of portfolios.

It is to be understood that the exemplary embodiments are merely illustrative of the invention and that many variations of the above-described embodiments can be devised by one skilled in the art without departing from the scope of the invention. It is therefore intended that all such variations be included Within the scope of the following claims and their equivalents.

What is claimed is:

1. A method of forming an exchange traded fund (ETF) comprising the steps of:
identifying an investor investment objective;
identifying existing funds to meet the investment objective;
combining the identified funds to form a macro portfolio;
analyzing the holdings of the identified funds of the macro portfolio; and
converting at least a portion of the holdings of the macro portfolio into an ETF.

2. The method of claim 1, wherein the step of identifying existing funds comprises screening through at least one of performance based attribution tools and holdings based attribution tools for specific investment characteristics that are desired to be replicated within the macro portfolio and the ETF.

3. The method of claim 1, wherein the step of combining the identified funds to form a macro portfolio comprises an equal weighting of the funds.

4. The method of claim 3, wherein the step of combining the identified funds to form a macro portfolio through an equal weighting of the funds comprises rebalancing the portfolio back to the equal weighting on a periodic basis.

5. The method of claim 1, wherein the step of combining the identified funds to form a macro portfolio comprises a weighting scheme for the funds that reflects a periodic adjustment designed to incorporate tactical asset allocation (TAA) decisions reflecting current macro-economic or investment views.

6. The method of claim 1, wherein the step of converting the macro portfolio into an ETF comprises one or more methods of generating a set of securities that, when combined, create a portfolio that tracks the performance of the macro portfolio.

7. The method of claim 6, further comprising determining the securities required to track the macro portfolio by way of accessing public disclosures of full or partial holdings made by the funds within the macro portfolio.

8. The method of claim 6, further comprising optimizing the portfolio of securities to reduce turnover.

9. The method of claim 6, further comprising optimizing the portfolio of securities to reduce the total number of holdings in the portfolio.

10. The method of claim 6, wherein the step of generating a set of securities that, when combined, create a portfolio that tracks the performance of the macro portfolio, comprises using a bottom-up approach.

11. The method of claim 10, further comprising obtaining the holdings for each underlying fund by accessing public disclosures of full or partial holdings made by the funds.

12. The method of claim 10, further comprising obtaining the holdings for each underlying fund by receiving them directly from the fund companies.

13. The method of claim 10, further comprising obtaining the holdings for each underlying fund by generating them through estimation or replication techniques.

14. The method of claim 6, wherein the step of generating a set of securities that, when combined, create a portfolio that tracks the performance of the macro portfolio, comprises using a top-down approach.

15. A method of forming an investable portfolio of securities, comprising the steps of:
identifying an investor investment objective;
identifying existing funds to meet the investment objective;
combining the identified funds to form a macro portfolio; and
generating a set of securities that, when combined, create a portfolio that tracks the performance of the macro portfolio.

16. The method of claim 15, further comprising wherein the step of identifying existing mutual funds comprises screening by analytical tools for specific investment characteristics that are desired to be replicated within the macro.

17. The method of claim 16, further comprising determining covariance between potential funds and selecting those funds that have higher covariance so that when combined together they provide better portfolio diversification.

18. The method of claim 15, further comprising determining covariance between potential funds and selecting those finds that have higher covariance so that when combined together they provide better portfolio diversification.

19. The method of claim 15, wherein the step of combining the identified funds comprises an equal weighting of the funds.

20. The method of claim 15, wherein the step of generating a set of securities that, when combined, create a portfolio that tracks the performance of the macro portfolio, comprises using a bottom-up approach.

21. The method of claim 15, wherein the step of generating a set of securities that, when combined, create a portfolio that tracks the performance of the macro portfolio, comprises using a top-down approach.

22. The method of claim 15, wherein the step of generating a set of securities that, when combined, create a portfolio that tracks the performance of the macro portfolio, comprises optimizing or otherwise modifying the portfolio of securities to meet SEC guidelines for investable indexes.

23. The method of claim 15, wherein the set of securities that, whet combined, create a portfolio that tracks the performance of the macro portfolio is then used to create a mutual fund.

24. The method of claim 15, wherein the set of securities that, when combined, create a portfolio that tracks the performance of the macro portfolio is then used to create a variable annuity.

25. The method of claim 15, wherein the set of securities that, when combined, create a portfolio that tracks the performance of the macro portfolio is then used to create a separately managed account.

26. The method of claim 15, wherein the set of securities that, when combined, create a portfolio that tracks the performance of the macro portfolio is then used to create a structured note or exchange traded note.

27. The method of claim 15, wherein the set of securities that, when combined, create a portfolio that tracks the performance of the macro portfolio is then used to create an institutional separate account.

28. The method of claim 15, wherein the set of securities that, when combined, create a portfolio that tracks the performance of the macro portfolio is then used to create an investment vehicle for delivering investment solutions to investors.

29. A method of forming an exchange traded fund (ETF) comprising the steps of:
identifying an investor investment objective;
identifying existing funds that can be combined together to meet the investment objective;
creating a fund index from the funds; and
building the ETF through investment management techniques that allows the ETF to effectively track the fund index.

30. The method of claim 29, wherein the step of combining the identified funds to form a fund index comprises all equal weighting of the funds.

31. The method of claim 29, wherein the step of combining the identified funds to form an fund index comprises a mechanism for systematically rebalancing the fund index back to its target or neutral weighting on a periodic basis, such as quarterly or annually.

32. A method of forming an exchange traded fund (ETF), comprising the steps of:
identifying an investor investment objective;
identifying existing funds to meet the investment objective;
combining the identified funds to form a macro portfolio;
generating a set of securities that, when combined, create a portfolio that tracks the performance of the macro portfolio,
converting the set of securities into a securities index; and
creating an ETF that tracks the securities index.

33. The method of claim 32, wherein the step of identifying existing funds comprises screening by analytical tools for specific investment characteristics.

34. The method of claim 32, wherein the step of generating a set of securities comprises using a bottom-up approach.

35. A method of forming an investable portfolio of securities, comprising the steps of:
identifying an investor investment objective;
identifying existing funds to meet the investment objective;
combining the identified funds to form a macro portfolio;
generating a set of securities that, when combined, create a portfolio that tracks the performance of the macro portfolio; and
creating a fund index from the funds.

36. The method of claim 35, further comprising wherein the step of identifying existing mutual funds comprises screening by analytical tools for specific investment characteristics that are desired to be replicated within the macro.

37. The method of claim 36, further comprising determining covariance between potential funds and selecting those funds that have higher covariance so that when combined together they provide better portfolio diversification.

38. The method of claim 35, further comprising determining covariance between potential funds and selecting those funds that have higher covariance so that when combined together they provide better portfolio diversification.

39. The method of claim 35, wherein the step of combining the identified funds comprises an equal weighting of the funds.

40. The method of claim 35, wherein the step of generating a set of securities that, when combined, create a portfolio that tracks the performance of the macro portfolio, comprises using a bottom-up approach.

41. The method of claim 35, wherein the step of generating a set of securities that, when combined, create a portfolio that tracks die performance of the macro portfolio, comprises using a top-down approach.

42. The method of claim 35, wherein die step of generating a set of securities that, when combined, create a portfolio that tracks the performance of the macro portfolio, comprises optimizing or otherwise modifying the portfolio of securities to meet SEC guidelines for investable indexes.

43. The method of claim 35, wherein the set of securities that when combined, create a portfolio that tracks the performance of the macro portfolio is then used to create a mutual fund.

44. The method of claim 35, wherein the set of securities that, when combined, create a portfolio that tracks the performance of the macro portfolio is then used to create a variable annuity.

45. The method of claim 35, wherein the set of securities that, when combined, create a portfolio that tracks the performance of the macro portfolio is then used to create a separately managed account.

46. The method of claim 35, wherein the set of securities that, when combined, create a portfolio that tracks the performance of the macro portfolio is then used to create a structured note or exchange traded note.

47. The method of claim 35, wherein the set of securities that, when combined, create a portfolio that tracks the performance of the macro portfolio is then used to create an institutional separate account.

48. The method of claim 35, wherein the set of securities that, when combined, create a portfolio that tricks the performance of the macro portfolio is then used to create an investment vehicle for delivering investment solutions to investors.
